(19) United States
(12) Patent Application Publication
(10) Pub. No.: US 2005/0238826 A1
(43) Pub. Date: Oct. 27, 2005

(54) Photo medium composition

(76) Inventors: Yubai Bi, San Diego, CA (US); Lori Books, Oceanside, CA (US); Douglas E. Knight, San Diego, CA (US); Pierre-Alain Brugger, Ependes (CH)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/833,245

(22) Filed: Apr. 27, 2004

(51) Int. Cl. B41M 5/00

(52) U.S. Cl. 428/32.24

(57) ABSTRACT

A photo medium composition includes a porous ink receiving layer having an alumina based pigment and at least one binder composition. The photo medium composition also includes a swellable imaging layer disposed on the porous ink receiving layer. The swellable imaging layer includes modified polyvinyl alcohols, polyurethanes, and at least one dye mordant.

### BACKGROUND

The present invention relates generally to photo media, and more particularly to a multi-layer photo medium composition.

Inkjet print media may include a swellable ink receiving layer (examples of which include gelatin and other hydrogels such as polyvinylpyrrolidone and polyvinyl alcohol) which is commonly used for inkjet photo-imaging. These media may generally, in some instances, provide better lightfastness, air fading resistance, durability and image quality than porous ink receiving media. However, swellable ink receiving layers may have relatively slow drying times, which may, in some instances, result in image transfer and ruined images.

Conventional porous ink receiving media may have relatively faster or substantially instant drying times than swellable ink receiving layers. Generally, it takes less time for a porous ink receiving layer to absorb ink than for a swellable ink receiving medium to swell and absorb ink. However, the image printed on porous media may in some cases be prone to a degree of fading due in part to light and/or air exposure.

Manufacturing such printed media typically involves a one path multilayer process or a multi-path multilayer process. The one path multilayer process generally requires the composition of each sublayer to be substantially completely compatible. An intermediate layer is added if the adjacent sublayers have deleterious interaction(s). This coating technology is generally used in a multilayer coating in which the sublayers are either all swellable or all porous.

A multi-path multilayer process is generally used when adjacent layers are not compatible or have very different physical and/or chemical properties. A two path process having a swellable layer on a porous layer has been developed. This process generally requires coating, drying, and rewetting the initial layer before depositing any subsequent layer due to the two layer incompatibility in wet-wet condition. A multi-path process may in some cases be sufficient to produce the desired end product, however, the process may also be relatively slow and somewhat expensive.

### SUMMARY

Embodiment(s) of the present invention substantially solve the drawbacks enumerated above by providing a photo medium composition. The photo medium composition includes a porous ink receiving layer having an alumina based pigment and at least one binder composition. The composition also includes a swellable imaging layer disposed on the porous ink receiving layer. The swellable imaging layer includes modified polyvinyl alcohols, polyurethanes, and at least one dye mordant.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1A is a cross-sectional schematic view of an embodiment of the present invention showing an embodiment of the substrate;

FIG. 1B is a cross-sectional schematic view of an embodiment of the present invention showing a porous ink receiving layer disposed on the substrate;

FIG. 1C is a cross-sectional schematic view of an embodiment of the present invention showing a swellable imaging layer disposed on the porous ink receiving layer;

FIG. 1D is a cross-sectional schematic view of an embodiment of the present invention showing an intermediate layer disposed on the porous ink receiving layer;

FIG. 1E is a cross-sectional schematic view of an embodiment of the present invention showing a swellable imaging layer disposed on the intermediate layer;

FIG. 2 is a cross-sectional schematic view of an embodiment of the present invention showing a photo medium system with various sub layers; and

FIG. 3 is a cross-sectional schematic view of an embodiment of the present invention showing a photo medium system with various sub layers and an intermediate layer of the photo medium composition.

### DETAILED DESCRIPTION OF THE EMBODIMENTS

Embodiments of novel and effective photo medium compositions 11, 11′ and systems 10, 10′ as described hereinbelow may advantageously provide rapid drying times and high quality print images. Without being bound to any theory, it is believed that this is due in part to the combination of a porous ink receiving layer and a swellable imaging layer. The photo medium compositions 11, 11′ and systems 10, 10′ according to embodiments of the present invention may be used in a variety of applications, including, but not limited to printing systems that employ thermal inkjet technology.

It is to be understood that the terms “disposed on”, “deposited on” and the like are broadly defined herein to encompass a variety of divergent layering arrangements and assembly techniques. These arrangements and techniques include, but are not limited to (1) the direct attachment of one material layer to another material layer with no intervening material layers therebetween; and (2) the attachment of one material layer to another material layer with one or more material layers therebetween provided that the one layer being “disposed on” or “deposited on” the other layer is somehow “supported” by the other layer (notwithstanding the presence of one or more additional material layers therebetween). The phrases “directly deposited on” or “deposited directly on” and the like are broadly defined herein to encompass a situation(s) wherein a given material layer is secured to another material layer without any intervening material layers therebetween. Any statement used herein which indicates that one layer of material is on another layer is to be understood as involving a situation wherein the particular layer that is “on” the other layer in question is the outermost of the two layers relative to incoming ink materials being delivered by the printing system of interest. It is to be understood that the characterizations recited above are to be effective regardless of the orientation of the photo medium materials under consideration.

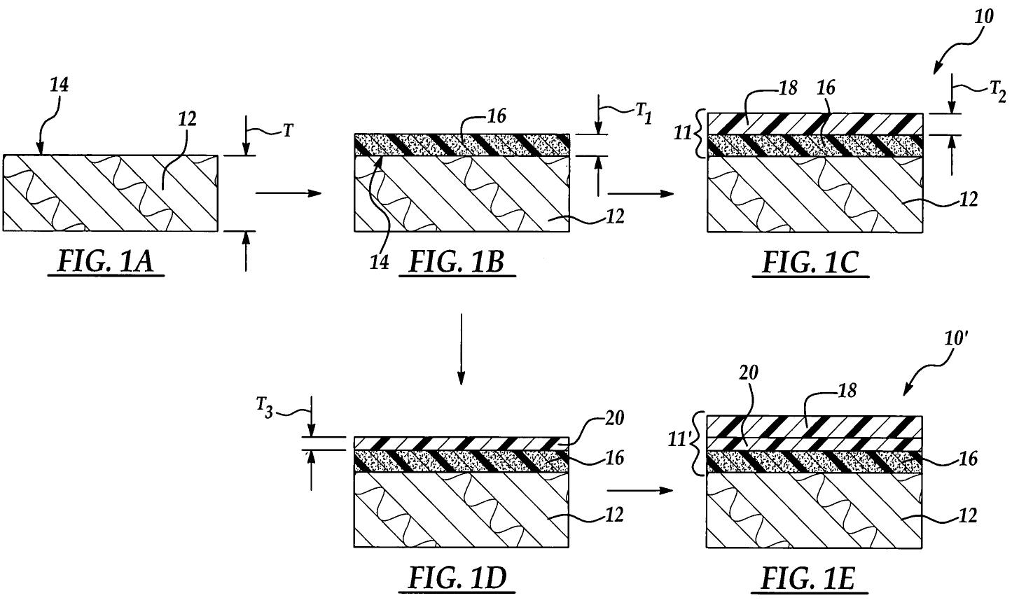

The various embodiments of the photo medium system 10, 10′ (shown respectively in FIGS. 1C and 1E) according to the present invention include a substrate 12, as depicted in FIG. 1A. In an embodiment, the substrate 12 is photopaper. However, it is to be understood that many different materials may be employed in connection with the substrate 12 including, but not limited to those made from paper, polymeric materials (non-limitative examples of which include polyester white film or polyester transparent film), photopaper (non-limitative examples of which include polyethylene or polypropylene extruded on one or both sides of paper), metals and/or mixtures thereof. A non-limitative example of a suitable metal material is a metal in foil form made from, for example, at least one of aluminum, silver, tin, copper, alloys thereof, and/or mixtures thereof. Furthermore, the substrate 12 may include an upper surface 14 upon which the various layers of embodiments of the present invention may be deposited. In an embodiment, the substrate 12 has a thickness T along substantially the entire length ranging between about 0.025 mm and about 0.5 mm.

The substrate 12 may be laminated/extruded with an ink-impermeable coating layer (not shown). One non-limitative example of a suitable ink-impermeable coating layer includes polyethylene. It is further contemplated that both sides of the substrate 12 may be coated with the ink-impermeable coating layer. In an embodiment, a layer of gelatin may further be deposited on the polyethylene ink-impermeable coating layer.

Embodiments of the photo medium system 10, 10′ include embodiments of the photo medium composition 11, 11′ of the present invention deposited on the substrate 12. The photo medium composition 11, 11′ of embodiments of the present invention includes at least one porous ink receiving layer 16, at least one swellable imaging layer 18 disposed thereon, and optionally an intermediate layer 20 disposed therebetween.

A method for making the photo medium system 10, 10′ according to an embodiment of the present invention includes the step of depositing at least one porous ink receiving layer 16 on an upper surface 14 of the substrate 12, as shown in FIG. 1B. Any suitable deposition technique/manufacturing process may be used to deposit the porous ink receiving layer 16 on the substrate 12. Some non-limitative examples of suitable deposition techniques/manufacturing processes include roll-coating, conventional slot-die processing, blade coating, slot-die cascade coating, curtain coating and/or other comparable methods including those that use circulating and non-circulating coating technologies. In certain instances, spray-coating, immersion-coating, and/or cast-coating techniques may be suitable for depositing part of the composition 11, 11′ but not the full multilayer assembly.

The porous ink receiving layer 16 may have a dry coat weight (irrespective of the coating method used) ranging between about 5 gsm and about 50 gsm.

Embodiments of the porous ink receiving layer 16 are designed to provide a high degree of “capacity” (e.g. ink-retention capability) in connection with the photo medium system 10, 10′ to facilitate rapid absorption of ink vehicles and therefore rapid drying of the printed image, to form a smooth/even surface, and/or to otherwise help to ensure that the desired gloss characteristics are maintained in the finished product. To accomplish these goals, the porous ink receiving layer 16 is generally non-swellable, or has a rigid structure, in the presence of liquids, with the term “porous” being basically defined in a conventional fashion to involve a structure or material having a plurality of pores therein through which fluids, etc. may pass and/or reside. The transfer of fluids (non-limitative examples of which include ink and the like) into and through the porous ink receiving layer 16 may occur via physical phenomena normally associated with porous materials including capillary action and the like.

The porous ink receiving layer 16 may have a representative and non-limiting uniform thickness T₁ along substantially its entire length ranging between about 1 μm and about 50 μm, although this range may be varied as necessary and/or as desired.

In an embodiment, the porous ink receiving layer 16 includes at least one pigment (namely, a material used to impart color, structure, void volume, opacity, and/or the like to a given formulation); and at least one binder composition (e.g. a composition having the ability to chemically, physically, and/or electrostatically retain one or more materials together in a given formulation or structure in order to provide mechanical strength, cohesiveness, and the like). The porous ink receiving layer 16 generally employs the two components listed above for the sake of simplicity and maximum effectiveness.

However, it is to be understood that other ingredients may also be incorporated within the porous ink receiving layer 16 in variable quantities including but not limited to crosslinking compounds (non-limitative examples include borates, titanium salts, melamine-formaldehyde which is commercially available under the tradename MADURIT MW from Vianova Resins GmbH located in Mainz, Germany, glyoxals, thiourea-formaldehydes, and commercially available CURESAN from BASF Corp. located in Mount Olive, N.J., and mixtures thereof), fillers, surfactants, light-stabilizers, preservatives (e.g. antioxidants), general stabilizers, and/or the like, and/or mixtures thereof. The quantity of the additional components may range between about 0.1% and about 1% of the total porous ink receiving layer 16. In a further embodiment, the quantity of the additional components may range between about 0.2% and about 0.3% of the total porous ink receiving layer 16.

In an embodiment, boric acid is added to the porous ink receiving layer 16 as a crosslinking compound in an amount ranging between about 0.2% and about 0.3%. It is to be understood that, if a crosslinking compound is included in the porous ink receiving layer 16, adding too much of the crosslinking compound may result in a decrease in porosity, causing coalescence in the porous ink receiving layer 16, while adding too little crosslinking compound may result in weak binding power, causing the porous ink receiving layer 16 to crack. While these additional components may be contained within the porous ink receiving layer 16, they are considered optional and may be employed as desired and/or necessitated by a particular end use.

The pigment(s) in the porous ink receiving layer 16 may be an alumina based pigment. The alumina based pigment may be doped with at least one element of the rare earth metal series of the periodic system of the elements with atomic numbers 57 to 71, non-limitative examples of which include lanthanum, ytterbium, praseodymium, cerium, neodymium and/or mixtures thereof. It is contemplated that the pigment may also have a pseudo-bohemite structure. Pseudo-bohemite is an agglomerate of aluminum oxide/hydroxide of formula Al₂O₃.nH₂O where n is from 1 to 1.5. In an embodiment, the aluminum oxide/hydroxide with a pseudo-bohemite structure is used in the form of its colloidal solution. In a further embodiment, the porous ink receiving layer 16 is formed from lanthanum doped-alumina.

It is to be understood that the alumina based pigment may be present in the dried porous ink receiving layer 16 in an amount ranging between about 50 wt. % and about 95 wt. %.

As previously stated, the porous ink receiving layer 16 has at least one binder composition combined with the alumina based pigment. Any suitable binder composition materials alone or in combination may be employed within the porous ink receiving layer 16. Some non-limitative examples include polyvinyl alcohol (PVOH), reactive PVOH (such as acetoacetyl modified PVOH), cationically modified PVOH (such as amine or ammonium modified PVOH), anionically modified PVOH, hydrophilic group modified PVOH, PVOH-copolymer polyethylene oxide (PEO), polyacrylate modified PVOH, polyvinylpyrrolidone (PVP), polyurethane, the copolymer of PVP and polyvinyl acetate, hydroxypropylcellulose, ethoxylated cellulose, polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, and/or derivatives thereof, and/or mixtures thereof.

The binder composition may be present in the porous ink receiving layer 16 in an amount ranging between about 5 wt. % and about 35 wt. %. In an alternate embodiment, the binder composition is present in the porous ink receiving layer 16 in an amount ranging between about 10 wt. % and about 15 wt. %.

Referring now to FIG. 1C, the method further includes depositing a swellable imaging layer 18 on the porous ink receiving layer 16. It is to be understood that any suitable deposition technique, as previously described, may be used. The swellable imaging layer 18 may have a dry coat weight (irrespective of the coating method used) ranging between about 3 gsm and about 15 gsm. In one non-limitative embodiment, the dry coat weight of the swellable imaging layer 18 is about 7 gsm.

The swellable imaging layer 18 is designed to provide high image quality to the various embodiments of the photo medium system 10, 10′ and to ensure the generation of clear, distinct images having a high color gamut. The swellable imaging layer 18 may be high-gloss, substantially non-porous, and generally swellable in the presence of liquids, with the term “non-porous” defined to include a structure or material which substantially lacks a plurality of pores therein through which fluids, etc. may pass. The transfer of fluids, including but not limited to ink and the like, into and through the swellable imaging layer 18 occurs via a physical phenomena typically associated with non-porous materials including non-capillary adsorption and the like.

It is contemplated that the swellable imaging layer 18 may have a representative and non-limiting uniform thickness T₂ along substantially its entire length ranging between about 4 μm and about 8 μm, although this range may be varied as necessary. In one non-limitative embodiment, the thickness T₂ is about 5.5 μm. It is contemplated that if the swellable imaging layer 18 is too thin, dye molecules may penetrate the porous ink receiving layer 16 resulting in poor color gamut of the image. However, if the swellable imaging layer 18 is too thick (generally having a thickness T₂ greater than about 8 μm), the ink vehicle may remain in the swellable imaging layer 18, resulting in a poorer dry time.

In an embodiment, the swellable imaging layer 18 includes a mixture of modified polyvinyl alcohols, polyurethanes, and/or dye mordants. It is to be understood that these materials may be combined in any suitable ratio. In an embodiment, the modified PVOH is present in an amount ranging between about 65 wt. % and about 92 wt. %, the polyurethanes are present in an amount ranging between about 5 wt. % and about 20 wt. %, and the dye mordants are present in an amount ranging between about 3 wt. % and about 15 wt. %.

It is to be further understood that other ingredients may also be incorporated within the swellable imaging layer 18 (see Examples 1 and 2). Some examples of the other ingredients that may be added to the swellable imaging layer 18 in variable quantities include but are not limited to surfactants, light stabilizers and preservatives. One non-limitative example of an additional ingredient in the swellable imaging layer 18 includes a predicated silica material, which is commercially available under the tradename ACEMATT HK 400, from Degussa located in Parsippany, N.J. The addition of this material to the swellable imaging layer 18 may aid in giving the final product a satin appearance as opposed to a glossy appearance (which is achieved when the predicated silica material is not present).

Suitable examples of modified PVOH include those previously described. Some non-limitative examples of suitable modified polyvinyl alcohols are acetoacetylated polyvinyl alcohols commercially available under the tradenames GOHSEFIMER Z-100, GOHSEFIMER Z-200, GOHSEFIMER Z-210 and GOHSEFIMER Z-320 from Nippon Gohsei located in Japan, and partially hydrolyzed polyvinyl alcohols commercially available under the tradenames AIRVOL 523 and AIRVOL 540 from Air Product and Chemicals, Inc. located in Allentown, Pa. and MOWIOL 18-88, 23-88, 26-88, 40-88, 47-88 or 56-88 from Clariant located in Muttenz, Switzerland.

Further, it is to be understood that any suitable polyurethane material may be used in the swellable imaging layer 18. Some suitable examples of a polyurethane material are commercially available under the tradenames PATELACOL IJ-30 and IJ-40 from Dainippon Ink and Chemicals/Dainippon International (USA), Inc. in Fort Lee, N.J. In an embodiment, the polyurethanes are present in an amount ranging between about 5 wt. % and about 20 wt. %. It is contemplated that if the polyurethane amount is less than about 5 wt. %, the dry time of the printed image will be slower and the gloss of the printed image may be reduced; and if the polyurethane amount is greater than about 20%, coalescence may develop when printing on an aged sample of the swellable imaging layer 18.

The swellable imaging layer 18 also includes any suitable dye mordant. In an embodiment, dye mordants are at least one of cationic monomers, cationic polymers (one non-limitative example of which is Polydimethyl-Dislkelen-Ammonium Chloride (polyDADMAC)), polyimines, and/or mixtures thereof. A non-limitative example of a suitable cationic monomer is commercially available tradename KYMENE 617 from Hercules Inc. located in Wilmington Del. Other suitable non-limitative examples of dye mordants are commercially available under the tradenames AMRES 8855 from Georgia Pacific located in Atlanta, Ga., CATFIX SWE and CATFIX 4440 from Clariant located in Muttenz, Switzerland, and NICCA JET 50, NICCA JET 100 and NICCA JET 450 from Nicca USA, Inc. located in Fountain Inn, S.C.

As previously stated, a suitable amount of dye mordant ranges between about 3 wt. % and about 15 wt. %. It is contemplated that if the amount is less than about 3 wt. %, the introduced dye may penetrate through the swellable imaging layer 18 and be absorbed by the porous ink receiving layer 16, resulting in lower color density. However, if the dye mordant is present in an amount higher than about 15 wt. %, the swellable imaging layer 18 may develop a yellow tone when exposed to oxygen, and the lightfastness of the printed images may be lower.

It is contemplated that the use of cationic monomers as dye mordants in the swellable imaging layer 18 substantially aids in the compatibility of the two layers 16, 18, due in part to the cationic dispersion of the alumina pigment in the porous ink receiving layer 16.

FIG. 1C illustrates one embodiment of the photo-imaging system 10 having one embodiment of the photo medium composition 11 thereon.

Prior to the deposition of the swellable imaging layer 18, the method may optionally include the step of depositing an intermediate layer 20 on the porous ink receiving layer 16, as depicted in FIG. 1D. The intermediate layer 20 may be made of any suitable material that is compatible with both the porous ink receiving layer 16 and the swellable imaging layer 18. Some non-limitative examples of suitable materials for the intermediate layer 20 include PVOH and/or modified PVOH and/or any other components that exist in, or are compatible with both the porous ink receiving layer 16 and the swellable imaging layer 18. Some examples of suitable materials for the intermediate layer 20 include, but are not limited to non-ionic surfactants and/or modified cellulose. A non-limitative example of a modified cellulose is hydro-methyl-propyl cellulose. It is to be understood that the intermediate layer 20 may be adapted to substantially further minimize any interaction between the porous ink receiving layer 16 and the swellable imaging layer 18, thus advantageously aiding in each of the layers' 16, 18 compatibility with the other.

The intermediate layer 20 may have any suitable thickness T₃. In an embodiment, the thickness T₃ ranges between about 0.1 μm and about 5 μm.

It is contemplated that the method for making the photo medium system 10, 10′ according to embodiments of the present invention offers the advantage of a one-path deposition process. The various layers 16, 18, 20 may be deposited using the one-path process, meaning that the particular subsequent layers may be deposited on the initial layer without having to first dry and rewet the initial layer. It is contemplated that this one-path process may be used when the various layers 16, 18, 20 are compatible with each other. It is to be understood that this one-path process may be achieved when the porous imaging layer 16 and the swellable imaging layer 18 are used or when all three layers 16, 18, 20 are used.

FIG. 1E illustrates an embodiment of the photo medium system 10′ having an embodiment of the photo medium composition 11′ thereon. The photo medium composition 11′ includes the intermediate layer 20 between the porous ink receiving layer 16 and the swellable imaging layer 18.

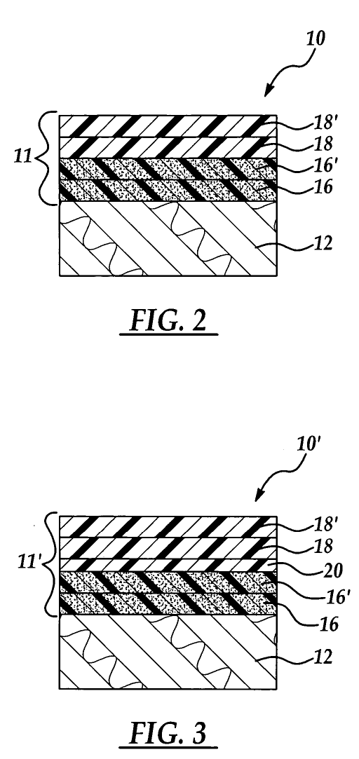

Referring now to FIG. 2, in an embodiment of the photo medium system 10 of the present invention, an embodiment of the photo medium composition 11 has multiple porous ink receiving layers 16, 16′ deposited on the substrate 12. It is to be understood that when various porous ink receiving layers 16, 16′ are deposited, at least one of the layers 16 is directly deposited on the substrate 12 or on the ink impermeable coating layer (if previously deposited on the substrate 12). In an embodiment in which more than one porous ink receiving layer 16, 16′ are deposited, it is contemplated that each of the layers 16, 16′ (regardless of how many are applied) may have the same or a slightly different ratio of binder composition to alumina pigment. For example, the porous ink receiving layer 16 deposited directly on the substrate 12 may have 89 wt. % pigment and 11 wt. % binder composition while the second porous ink receiving layer 16′ may have 91 wt. % pigment and 9 wt. % binder composition. In this embodiment, each of the porous ink receiving layers 16, 16′ may have a thickness T₁ ranging between about 1 μm and about 49 μm, with the total thickness of all the porous ink receiving layers 16, 16′ ranging between about 2 μm and about 50 μm.

It is to be understood that more than one swellable imaging layer 18, 18′ may also be deposited on the porous ink receiving layer(s) 16, 16′. In an embodiment in which more than one swellable imaging layer 18, 18′ are deposited, it is contemplated that each of the sub layers may have the same or a slightly different ratio of modified PVOH, polyurethane, and dye mordant. For example, the swellable imaging layer 18 deposited directly on the porous ink receiving layer 16 may have a high dye mordant content and a low polyurethane content (e.g. about 0.01 wt. %) while the second swellable imaging layer 18′ may have between about 5 wt. % and about 20 wt. % polyurethane. It is contemplated that this embodiment may aid in minimizing any interaction between the polyurethane and the porous ink receiving layer 16. In this embodiment, each of the swellable ink receiving layers 18, 18′ may have a thickness ranging between about 1 μm and about 4 μm, with the total thickness of all the swellable ink receiving layers 18, 18′ ranging between about 4 μm and about 8 μm.

It is contemplated that in the photo medium composition, one porous ink receiving layer 16 may be employed with multiple swellable imaging layers 18, 18′ and that multiple porous ink receiving layers 16, 16′ may be employed with one swellable imaging layer 18.

FIG. 3 depicts an embodiment of the photo medium system 10′ having an alternate embodiment of the photo medium composition 11′ thereon. The photo medium composition 11′ includes multiple porous ink receiving layers 16, 16′ and multiple swellable imaging layers 18, 18′, with the intermediate layer 20 disposed therebetween.

To further illustrate the photo medium composition and system disclosed herein, reference is made to the following examples. The examples are for illustrative purposes and are not intended to limit the scope of the present disclosure.

### EXAMPLE 1

The porous ink receiving layer is prepared by mixing 25.0 gsm (unless otherwise stated, weights are dry weights) La-AlOOH (with 81 mg LaNitrate/m²), 2.1 gsm PVOH M05698, 0.91 gsm PVOH M02688, 0.007 gsm lactic acid, 0.075 gsm boric acid, 0.055 gsm glycerine, and 0.09 gsm welting Olin10G together. The porous ink receiving layer is deposited on one square meter of gelatin subbed polyethylene extruded photobase substrate by cascade and curtain die coating technologies. The porous ink receiving layer has a wet coat weight of 113.6 gsm. It is to be understood that wet coat weight includes the amount of water added to the original coating layer that is driven off in a drying process. An intermediate layer is prepared by mixing 1.8 gsm PVOH MO2688 with 0.011 gsm welting Olin10G (a non-ionic surfactant commercially available from Arch Chemicals, Inc. located in Norwalk, Conn.). The intermediate layer has a wet coat weight of 21.4 gsm and is deposited on the porous ink receiving layer by cascade and curtain die coating technologies. Two swellable imaging layers are prepared and deposited on the intermediate layer. The first swellable imaging layer contains a mixture of 2.88 gsm Gohsefimer Z-200, 0.315 gsm Patelacol IJ-30, 0.27 gsm Amres 8855 and 0.009 gsm welting Olin10G. The first swellable imaging layer is deposited on the intermediate layer by cascade and curtain die coating technology and has a wet coat weight of 34 gsm. The second swellable imaging layer contains a mixture of 2.88 gsm Gohsefimer Z-200, 0.315 gsm Patelacol IJ-30, 0.27 gsm Amres 8855, 0.027 gsm welting Olin10G and 0.007 gsm Fluoro Lodyne107. The second swellable imaging layer is deposited on the first swellable imaging layer by cascade and curtain die coating technology and it has a wet coat weight of 34 gsm. The total wet coat weight of the photo medium composition is 203.0 gsm.

### EXAMPLE 2

All of the layers are prepared and deposited in the same manner as described in Example 1 except for the preparation of the intermediate layer and the swellable imaging layers. The intermediate layer is prepared by mixing 1.8 gsm Gohsefimer Z-200 and 0.011 gsm wetting Olin10G. The intermediate layer has a wet coat weight of 21.4 gsm. The first swellable imaging layer contains a mixture of 2.88 gsm Gohsefimer Z-200, 0.315 gsm Patelacol IJ-40, 0.27 gsm Kymene 617, 0.009 gsm wetting Olin10G and 0.212 gsm Acematt HK400, giving the first swellable imaging layer a wet coat weight of 34.9 gsm. The second swellable imaging layer contains a mixture of 2.88 gsm Gohsefimer Z-200, 0.315 gsm Patelacol IJ-40, 0.27 gsm Kymene 617, 0.027 gsm wetting Olin10G, 0.007 gsm Fluoro Lodyne107 and 0.1 gsm Acematt HK400 added, resulting in a wet coat weight of 34.2 gsm. The total wet coat weight of the composition is 204.1 gsm.

Embodiments of the present invention may provide many advantages, examples of which include, but are not limited to the following. Embodiments of the present invention may advantageously result in fast drying of the ink due in part to the low ink vehicle retaining power of the swellable imaging layer. The porous ink receiving layer may advantageously absorb the liquid vehicles of the ink, allowing for fast drying times and allowing the swellable imaging layer to advantageously maintain its integrity after printing. Further, embodiments of the present invention may advantageously result in improved resistance to air and light fading. It is believed that this light and air resistance may be due in part to the combination of the swellable imaging layer on the porous ink receiving layer eliminating the exposed large surface area generally typical of porous media and allowing the dye molecules to be absorbed and maintained into the swellable imaging layer. It is contemplated that the absorption of the dye molecules in the swellable layer also advantageously results in a higher color gamut of the resulting image. Without being bound to any theory, it is believed that, generally as a result of the combination of the swellable imaging layer on the porous ink receiving layer, high image quality is maintained while also allowing for fast drying times. Embodiments of the method of the present invention generally advantageously allow for single path coating, which may improve manufacturing efficiency and costs. It is believed that one path coating is achieved because the interactions between the porous ink receiving layer and the swellable imagaing layer are minimized, while maintaining the image quality of two path coating. This may be due in part to the porous ink receiving layer 16 and the swellable imaging layer 18 having substantially similar chemistries, and/or to the introduction of an intermediate layer 20.

While several embodiments of the invention have been described in detail, it will be apparent to those skilled in the art that the disclosed embodiments may be modified. Therefore, the foregoing description is to be considered exemplary rather than limiting.

1. A photo medium composition, comprising:
a porous ink receiving layer comprising an alumina based pigment and at least one binder composition; and
a swellable imaging layer disposed on the porous ink receiving layer, the swellable imaging layer comprising modified polyvinyl alcohols, polyurethanes, and at least one dye mordant.

2. The photo medium composition as defined in claim 1 wherein the alumina based pigment is present in the porous ink receiving layer in an amount ranging between about 50 wt. % and about 95 wt. %.

3. The photo medium composition as defined in claim 1 wherein the alumina based pigment comprises lanthanum doped alumina.

4. The photo medium composition as defined in claim 1 wherein the at least one binder composition is present in the porous ink receiving layer in an amount ranging between about 5 wt. % and about 35 wt. %.

5. The photo medium composition as defined in claim 1 wherein the at least one binder composition comprises at least one of polyvinyl alcohol, reactive polyvinyl alcohol, cationically modified polyvinyl alcohol, anionically modified polyvinyl alcohol, hydrophilic group modified polyvinyl alcohol, polyvinyl alcohol-copolymer polyethylene oxide, polyacrylate modified polyvinyl alcohol, polyvinylpyrolidone, polyurethanes, polyvinylpyrolidone and polyvinyl acetate copolymers, hydroxypropylcellulose, ethoxylated cellulose, polyester, polyester-melanine, styrene-acrylic acid copolymers, styrene-acrylic acid-alkyl acrylate copolymers, styrene-maleic acid copolymers, styrene-maleic acid-alkyl acrylate copolymers, styrene-methacrylic acid copolymers, styrene-methacrylic acid-alkyl acrylate copolymers, styrene-maleic half ester copolymers, vinyl naphthalene-acrylic acid copolymers, vinyl naphthalene-maleic acid copolymers, derivatives thereof, and mixtures thereof.

6. The photo medium composition as defined in claim 5 wherein the at least one binder composition is polyvinyl alcohol and is present in the porous ink receiving layer in an amount ranging between about 10 wt. % and about 15 wt. %.

7. The photo medium composition as defined in claim 1 wherein the at least one binder composition further comprises at least one crosslinking compound.

8. The photo medium composition as defined in claim 7 wherein the at least one crosslinking compound comprises at least one of boric acids, borates, titanium salts, melamine-formaldehydes, glyoxals, thiourea-formaldehydes, and mixtures thereof.

9. The photo medium composition as defined in claim 1, further comprising an intermediate layer disposed between the porous ink receiving layer and the swellable imaging layer, and adapted to minimize interaction between the porous ink receiving layer and the swellable imaging layer.

10. The photo medium composition as defined in claim 9 wherein the intermediate layer comprises at least one of polyvinyl alcohols, modified polyvinyl alcohols, non-ionic surfactants, modified celluloses, and mixtures thereof.

11. The photo medium composition as defined in claim 9 wherein the intermediate layer has a thickness ranging between about 0.1 μm and about 5 μm.

12. The photo medium composition as defined in claim 1 wherein the porous ink receiving layer has a dry coat weight ranging between about 5 gsm and about 50 gsm.

13. The photo medium composition as defined in claim 1 wherein the swellable imaging layer has a dry coat weight ranging between about 3 gsm and about 15 gsm.

14. The photo medium composition as defined in claim 1 wherein the at least one dye mordant comprises a cationic compound.

15. The photo medium composition as defined in claim 1 wherein the porous ink receiving layer comprises between about 50 wt. % and about 95 wt. % alumina based pigment and between about 5 wt. % and about 35 wt. % binder composition, and the swellable imaging layer comprises between about 65 wt. % and about 92 wt. % modified polyvinylalcohols, between about 5 wt. % and about 20 wt. % polyurethanes, and between about 3 wt. % and about 15 wt. % dye mordant.

16. The photo medium composition as defined in claim 1 wherein the porous ink receiving layer has a thickness ranging between about 1 μm and about 50 μm.

17. The photo medium composition as defined in claim 1 wherein the swellable imaging layer has a thickness ranging between about 4 μm and about 8 μm.

18. A photo medium composition, comprising:
a plurality of porous ink receiving layers, each of the plurality of porous ink receiving layers comprising a predetermined ratio of lanthanum doped alumina based pigment to binder composition;
an intermediate layer disposed on the plurality of porous ink receiving layers; and
a plurality of swellable imaging layers disposed on the intermediate layer, each of the plurality of swellable imaging layers comprising a predetermined ratio of modified polyvinyl alcohol to polyurethane to dye mordant.

19. The photo medium composition as defined in claim 18 wherein at least one of the plurality of ink receiving layers comprises an auxiliary component.

20. The photo medium composition as defined in claim 19 wherein the auxiliary component comprises at least one of crosslinking compounds, fillers, surfactants, light-stabilizers, preservatives, general stabilizers, and mixtures thereof.

21. The photo medium composition as defined in claim 18 wherein the intermediate layer comprises at least one of polyvinyl alcohols, modified polyvinyl alcohols, non-ionic surfactants, modified celluloses, and mixtures thereof.

22. The photo medium composition as defined in claim 18 wherein each of the plurality of porous ink receiving layers has a thickness ranging between about 1 μm and about 49 μm.

23. The photo medium composition as defined in claim 18 wherein each of the plurality of swellable imaging layers has a thickness ranging between about 1 μm and about 4 μm.

24. The photo medium composition as defined in claim 18 wherein the intermediate layer has a thickness ranging between about 0.1 μm and about 5 μm.

25. A photo medium system for inkjet printing, comprising:
a substrate;
a porous ink receiving layer disposed on the substrate, the porous ink receiving layer comprising a lanthanum doped alumina based pigment, and at least one binder composition;
an intermediate layer disposed on the porous ink receiving layer; and
a swellable imaging layer disposed on the intermediate layer, the swellable imaging layer comprising modified polyvinyl alcohols, polyurethanes, and at least one dye mordant.

26. The photo medium system as defined in claim 25 wherein the porous ink receiving layer comprises between about 50 wt. % and about 95 wt. % of the alumina based pigment and between about 5 wt. % and about 35 wt. % of the at least one binder composition.

27. The photo medium system as defined in claim 25 wherein the at least one dye mordant is a cationic monomer.

28. The photo medium system as defined in claim 25 wherein the substrate comprises at least one of papers, polymeric materials, metals, photopaper, and mixtures thereof.

29. The photo medium system as defined in claim 25 wherein the porous ink receiving layer has a dry coat weight ranging between about 5 gsm and about 50 gsm and wherein the swellable imaging layer has a dry coat weight ranging between about 3 gsm and about 15 gsm.

30. The photo medium system as defined in claim 25 wherein the intermediate layer is adapted to minimize interaction between the porous ink receiving layer and the swellable imaging layer.

31. The photo medium system as defined in claim 25 wherein the intermediate layer comprises at least one of polyvinyl alcohols, modified polyvinyl alcohols, non-ionic surfactants, modified celluloses, and mixtures thereof.

32. A method of making a photo medium system, the method comprising the steps of:
depositing at least one porous ink receiving layer on a substrate, the porous ink receiving layer comprising an alumina based pigment and at least one binder composition; and
depositing at least one swellable imaging layer on the at least one porous ink receiving layer, the swellable imaging layer comprising modified polyvinyl alcohols, polyurethanes, and at least one dye mordant.

33. The method as defined in claim 32, further comprising the step of depositing an intermediate layer on the at least one porous ink receiving layer prior to the deposition of the at least one swellable imaging layer.

34. The method as defined in claim 33 wherein the intermediate layer comprises at least one of polyvinyl alcohols, modified polyvinyl alcohols, non-ionic surfactants, modified celluloses, and mixtures thereof.

35. The method as defined in claim 32 wherein the alumina based pigment comprises lanthanum doped alumina.

36. The method as defined in claim 32 wherein the depositing steps are accomplished by at least one of roll-coating, slot-die processing, blade coating, slot-die cascade coating, curtain coating, and combinations thereof.

37. The method as defined in claim 32 wherein the porous ink receiving layer comprises between about 50 wt. % and about 95 wt. % of the alumina based pigment and between about 5 wt. % and about 35 wt. % of the at least one binder composition.

38. A method of making a photo medium system, comprising the step of:
depositing a photo medium composition on a substrate, the photo medium composition comprising:
a porous ink receiving layer comprising an alumina based pigment doped with at least one of lanthanum, ytterbium, praseodymium, cerium, neodymium, and mixtures thereof and at least one binder composition; and
a swellable imaging layer disposed on the porous ink receiving layer, the swellable imaging layer comprising modified polyvinyl alcohols, polyurethanes, and at least one dye mordant.

39. The method as defined in claim 38 wherein the photo medium composition further comprises an intermediate layer disposed between the porous ink receiving layer and the swellable imaging layer, the intermediate layer comprising at least one of polyvinyl alcohols, modified polyvinyl alcohols, non-ionic surfactants, modified celluloses, and mixtures thereof.

40. The method as defined in claim 38 wherein the depositing is accomplished by at least one of roll-coating, slot-die processing, blade coating, slot-die cascade coating, curtain coating, and combinations thereof.
